(19) United States
(12) Patent Application Publication
(10) Pub. No.: US 2006/0032679 A1
(43) Pub. Date: Feb. 16, 2006

(54) Trailer tongue scale

(76) Inventors: William E. Wilson, Lakewood, CO (US); Steven H. Wilson, Lakewood, CO (US)

Correspondence Address: Peter B. Scull;Dahl & Osterloth, LLP, Suite 3405, 555 17th Street, Denver, CO, 80202-3937, US

(21) Appl. No.: 10/917,795

(22) Filed: Aug. 13, 2004

(51) Int. Cl. G01G 19/08; G01G 19/52; G01G 19/02

(52) U.S. Cl. 177/136; 177/146

(57) ABSTRACT

Trailer tongue scale including a frame having at least one angularly disposed strut; a sleeve connected to and supported by the angularly disposed strut; and a force sensitive device connected to the frame such that the frame supports the force sensitive device; and a force indication device operable with the force sensitive device to reflect an amount of a force imposed upon the force sensitive device, the reflected amount being indicative of a force measurement; and a force transmission rod assembly disposed to move within the sleeve and disposed in operative communication with the force sensitive device and disposed to be operatively connected to a trailer tongue and thereby receive a force therefrom and transmit that force to the force sensitive device which provides for the force indication device to reflect the amount of that force. The scales may alternatively be disposed to provide an adjustable height.

### BACKGROUND

The present invention relates generally to trailers of various kinds and the relationship between trailer tongue weight and the control and safety of the towing vehicle and the towed trailer. This invention relates more particularly to a scale for indicating the dead load supported by the towing vehicle at the ball and socket connection point.

Measuring and maintaining a proper tongue weight on trailers when loaded has been found highly desirable. Improper tongue weight can cause problems with the towing vehicle and/or the towed trailer. Too little tongue weight can cause traction problems for the towing vehicle and/or problems with trailer control. Too much tongue weight, on the other hand, can cause steering and/or braking problems for the towing vehicle. There are also weight limits for the hitch of the tow vehicle which too may be undesirably exceeded.

An often-described method of determining trailer tongue weight involves using a human weight scale, often referred to as a bathroom scale, together with a brick and a board. The board is placed so that it is supported on one end by the bathroom scale and on the other end by a brick located at approximately the same height as the bathroom scale. The trailer tongue is located midway between the bathroom scale and the supporting brick. The trailer hitch jack is then positioned on the approximate center of the board to support the trailer. The bathroom scale then indicates approximately one-half of the total tongue weight. More specifically, doubling the bathroom scale reading provides the tongue weight. If the hitch jack is supported at a position other than the center of the board, the scale reading would then be multiplied by the ratio of the total board length divided by distance from the brick to the hitch jack to obtain the tongue weight. This is a procedure recommended by trailer manufacturers who suggest it be carried out every time the load in the trailer is changed.

Some prior devices have been designed for use in conjunction with an existing trailer jack tube. Such devices measure tongue weight behind the actual ball and socket connection point and/or require the use of other means of support and height adjustment and/or modifications to existing trailer equipment. Some other trailer couplings have been provided with weight indicating devices formed as a part thereof. The type of construction of these devices requires modification of the basic trailer hitch in order to accommodate the weighing device.

### SUMMARY

Disclosed herein are varieties of trailer tongue scales which may include a frame having at least one angularly disposed strut; a sleeve connected to and supported by the angularly disposed strut; and a force sensitive device connected to the frame such that the frame supports the force sensitive device; and a force indication device operable with the force sensitive device to reflect an amount of a force imposed upon the force sensitive device, the reflected amount being indicative of a force measurement; and a force transmission rod assembly disposed to move within the sleeve and disposed in operative communication with the force sensitive device and disposed to be operatively connected to a trailer tongue and thereby receive a force therefrom and transmit that force to the force sensitive device which provides for the force indication device to reflect the amount of that force. The scales may alternatively be disposed to have one or more conventional trailer adjustment devices attached thereto, and/or may be disposed to provide an adjustable height.

Other features and advantages of the present invention will become apparent to one with skill in the art upon examination of the following drawings and detailed description. It is intended that all such features and advantages are included within the scope of the present invention, as defined in the appended claims.

### BRIEF DESCRIPTION OF DRAWINGS

The present invention, as defined in the claims, can be better understood with reference to the following drawings. The drawings are not intended to be to scale, emphasis instead being placed on clearly illustrating the principles of the present invention.

In the drawings:

FIG. 1 is an elevational view of a trailer tongue scale operatively disposed relative to a trailer as described herein;

FIG. 2 is an isometric view of a trailer tongue scale as described herein;

FIG. 3 is an elevational view of a trailer tongue scale like that in FIG. 2;

FIG. 4 is a cross-sectional view of a trailer tongue scale as may be taken along line 4-4 of FIGS. 2 and/or 3.

FIG. 5 is a top plan view of a trailer tongue scale like those in FIGS. 2 -4;

FIG. 6 is a frontal elevational view of an alternative trailer tongue scale hereof;

FIG. 7 is a side elevational view of an alternative trailer tongue scale like that in FIG. 6;

FIG. 8 is a cross-sectional view of an alternative trailer tongue scale like that in FIGS. 6 and 7 as may be taken along line 8-8 of FIG. 7; and,

FIG. 9 is a partially cut away, cross-sectional view of an alternative trailer tongue scale like that in FIGS. 6, 7 and 8 as may be taken along line 8-8 of FIG. 7.

### DETAILED DESCRIPTION

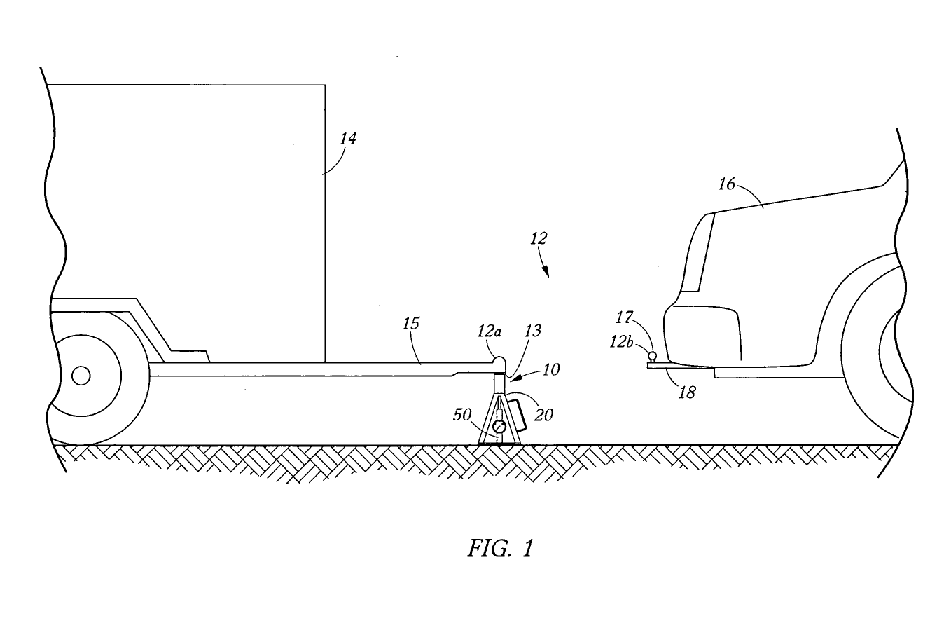

Various embodiments of a trailer tongue scale are hereafter described in detail and are generally identified in the attached drawings by the substantially generic reference numeral 10. Such a scale 10 may be used to indicate actual trailer tongue weight at the ball and socket connection point 12, see reference numerals 12a and 12b for the respective socket and ball portions thereof in FIG. 1. The determination of this weight may provide assistance in the process of appropriately distributing the weight of any cargo in a trailer 14, which thereby contributes to the safe operation of a trailer 14 and a corresponding towing vehicle 16.

Note, references to weight herein are intended to encompass the related physical qualities or characteristics of mass, force and/or pressure, any of which being potentially measured or measurable hereby, any of which being useful as an indication of the downward effect (e.g., force or pressure) applied at/by the trailer tongue 15 to/on the universal hitch ball 17 and the towing hitch 18 of the tow vehicle 16. It may more generally be described that this downward force, as hereafter referred to as representative of weight, mass, pressure or the like, which if inappropriate (too light or too heavy) can then cause any of many undesirable outcomes such as those described briefly above or as may otherwise occur. Thus, used and/or included herein may be any of the physical indications of mass, force, pressure or otherwise, which may be indicative of the ultimate physical impact or effect of the trailer 14 and trailer tongue 15 applied via the socket 13 on/at the connection 12 and thereby to the ball 17, the tow hitch structure 18, and/or consequently to the vehicle 16.

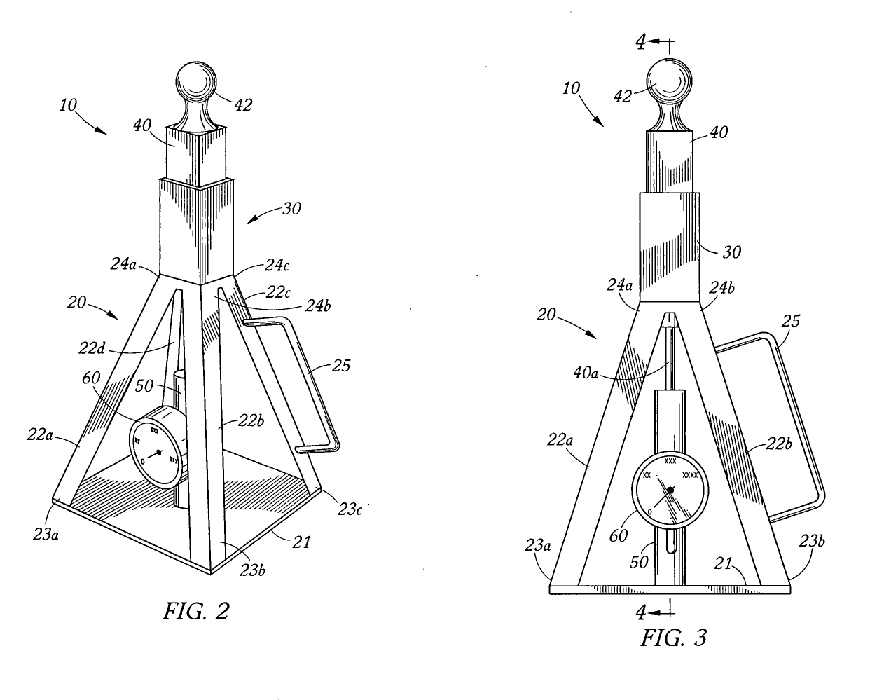

Referring more specifically now to FIGS. 2-5 of the drawings, there is shown a more detailed embodiment of a tongue scale 10 of the present invention. Such a scale 10 generally includes a main frame or stand 20 with a sleeve 30 in which may be disposed a movable force rod 40 connecting via a narrowed rod portion 40a with a measurement cylinder 50 having a gauge 60. The frame 20 is disposed to support the sleeve 30 in a substantially fixed operative position which serves to support and guide the force rod 40 as it transmits the weight force to the cylinder 50.

The frame 20 may, as shown, include a substantially flat base 21 and one or a plurality of generally upstanding structural supporting members, legs or struts 22, each of the individual struts 22 being more specifically identified using alphabetical suffixes, as in 22a, 22b, 22c and 22d in FIGS. 2-5. Though four struts are shown here; one, two, three or any other reasonable number may be included. In this embodiment, the struts 22a, 22b, 22c and 22d are angularly disposed reaching from respective lower and outer frame corners 23, specifically, respective corners 23a, 23b, 23c and 23d of the frame 20 upward and inward to the sleeve 30. Note, the respective corners 23a, 23b, 23c and 23d may also or alternatively represent the corresponding lower ends of the respective struts 22a, 22b, 22c and 22d. The struts 22a, 22b, 22c and 22d are then connected at their respective upper ends 24, e.g. ends 24a, 24b, 24c and 24d, to and support the sleeve 30 in a substantially stationary operative position. When angularly disposed, the struts may provide vertical and lateral support. An optional handle 25 is shown in FIGS. 2, 3 and 5 as one alternative for carrying or otherwise maneuvering a scale 10.

As introduced above, the scale 10 may include a tubular and/or hollowed sleeve 30 which may serve to receive, support laterally and guide a force rod 40 as it may be disposed and/or move therewithin in operation of the scale 10. The guide force rod 40 shown here has a universal trailer ball 42 mounted there atop, although other connection means such as a pintle hitch or tow ring may be used. As introduced above, the ball 42 may be adapted to be connected within a corresponding socket 13 of the trailer tongue 15. Weight or pressure force then applied to the ball 42 will then be transmitted or transferred along the length of the rod 40 including the narrowed portion 40a thereof to the measurement cylinder 50. The corresponding mass, weight and/or pressure force may then be displayed on the gauge 60.

Sleeve 30 is selected to be of substantially the same or typically a slightly larger inner diameter than the outer diameter of rod 40. Direct or nearly direct mating of the sizes of the rod 40 to the sleeve 30 may provide for or assist in the provision of lateral support to the rod 40 and thus an overall safe, stable weighing device 10. As the tolerances get small enough, lubrication may be desired or needed. Sleeve 30 may thus be a support sleeve. And, sleeve 30 may be formed in a shape and/or from a material to allow the rod 40 to slide easily vertically therein and/or therethrough. Sleeve 30 may also be selected to be of sufficient length and strength so that when weight/force is applied from the ball 42 to and through the rod 40 to the cylinder 50, the rod 40 remains secured within the sleeve 30 and frame 20 during the weighing measurement of the trailer tongue load. This may provide safety by preventing accidental movement and/or dislodging of rod 40 from scale 10. The intra-movability of the rod 40 within the sleeve 30 and the preferable close tolerances therebetween also provides for the sleeve 30 to control and guide the rod 40 directly onto/into the cylinder 50. Sleeve 30 may thus also or alternatively be a guide sleeve.

The frame 20 may also provide assistance in the secure control of the movement of the rod 40 in the sleeve 30. As introduced, the struts 22 hold the sleeve in operative, preferably immovable position, and as such, the struts 22 may act to counteract any possible lateral forces applied to the sleeve 30 by the rod 40, the rod 40 perhaps having generally received and transmitted such forces from the application of any lateral forces or movement to/on the ball 42 via the socket 13, trailer tongue 15 and initially the trailer 14. The as shown relatively lateral disposition of the strut lower ends 23 from the strut upper ends 24 may thereby be used to have the struts 22 provide stability against any such lateral forces or movement. Thus, in many embodiments, a relatively broad base may be provided by the frame 20 and its struts 22 to thereby provide enhanced lateral stability, security and/or safety in use.

Moreover, the struts 22 may also be intended to provide vertical support sufficient to at least, or preferably, more than withstand any weight force or pressure applied thereto by the trailer tongue 15. Thus, depending upon the ultimate weights to be experienced as well as depending upon the frame materials chosen, and at times also the type of measurement cylinder 50, discrete angles of disposition of the struts 22 relative to either the ground or the vertical, may alternatively be chosen. As shown, the angle relative to the ground for each of the struts 22 may be about 60 degrees, with corresponding angles relative to the vertical at about 30 degrees. However, these may be interchanged and/or many other angles therebetween, or lesser, or greater may be chosen. Moreover, the struts 22 may occupy or at least appear to occupy a plurality of angles simultaneously (particularly when viewed as projections of elevations), as for example if, the struts extended to rectangular plan points, rather than the square plan shown here, see particularly FIG. 5 which also depicts in phantom an alternative rectangular extension 27 of the corners 123c and 123d. Then, the ground angles on the short sides of the rectangle would generally be larger than the corresponding ground angles on the longer sides of the rectangle for each strut. And, other plan dispositions, either regular, e.g., circular, elliptical, equilateral triangular, or irregular, ovate, non-equilateral triangular or others, may be used. If regular plans, then each strut would most likely have the same or similar angular dispositions as each other strut, but if irregular plans are used then some or even each strut may have discrete angular dispositions.

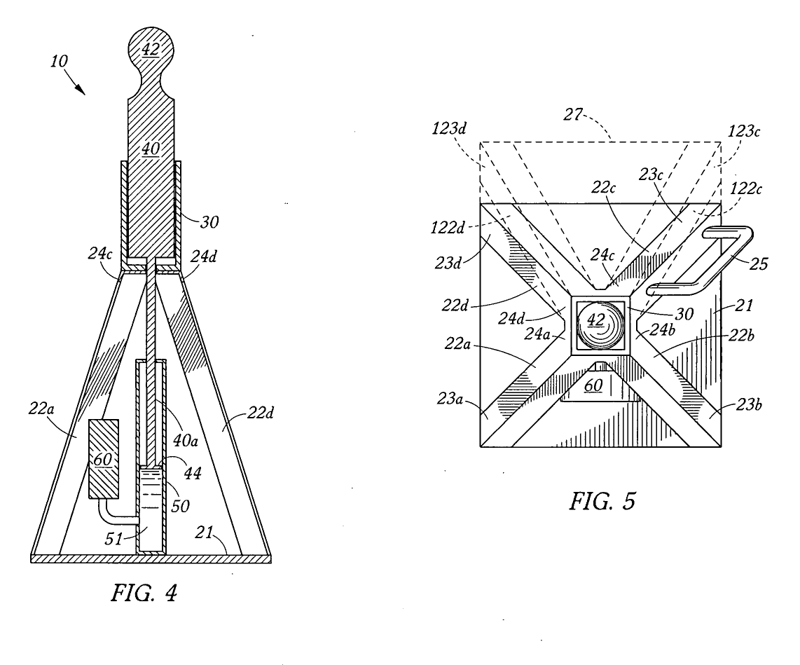

The cylinder 50 may, as indicated, be hydrostatic (sometimes referred to as hydraulic), or pneumatic with, as shown more particularly in FIG. 4, the lower end of the rod 40 usually then connected to a piston 44 in pressure contact with a pressure and/or weight sensitive, i.e., force sensitive medium 51 in the cylinder 50. In hydrostatic or pneumatic or like examples, the medium 51 would generally be a fluid medium (hydraulic fluid, oil or air, inter alia), compressible, or simply responsive to pressure or other force. The medium 51 in the cylinder will generally be responsive to the force or pressure applied thereto by the piston 44 to provide a pressure or weight (force) reading on the gauge 60. In such cases, gauge 60 would be in pressure/weight/force sensing relationship therewith and calibrated to provide a readable indication of the pressure or other force applied therein. As shown in FIGS. 2, 3 and 4, the cylinder 50 is disposed with a closed bottom end on the base 21, where however, the cylinder 50 could otherwise be connected to the frame 20 at or to any one or more of the struts 22 and/or to the tubular sleeve member 30, even though such an alternative connection would more likely be to the top or side or sides of the cylinder 50. As such, the base 21 may not be flat and/or may not be below the cylinder 50, but, may rather be a structure which supports the connection of the cylinder 50 with the frame 20 and/or with the sleeve 30, or perhaps even separate from the device 10, but secured in a stable position relative to the device 10.

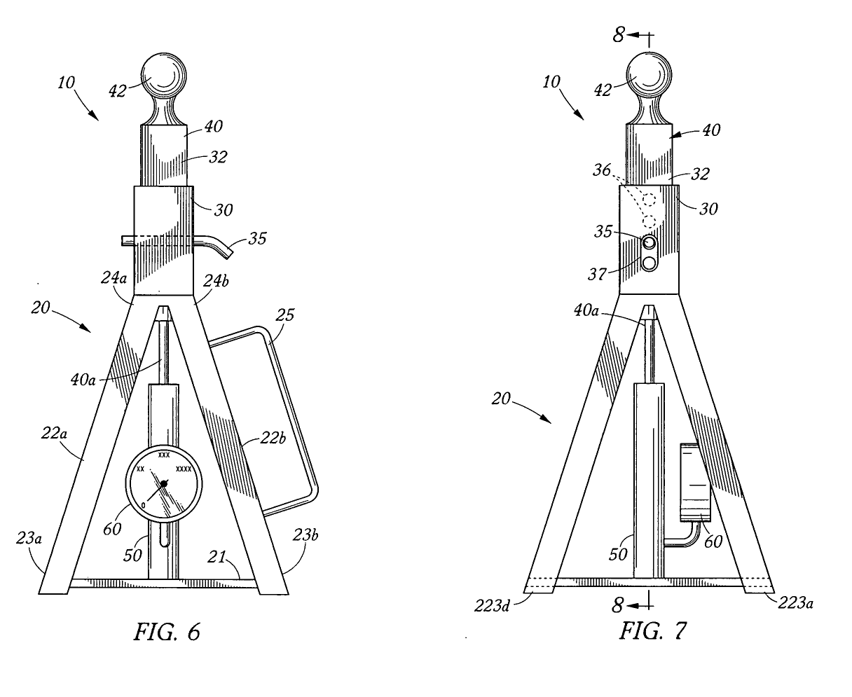

As shown in the alternative embodiments of FIGS. 6, 7, 8 and 9, a further inner sleeve 32 may be used as a part of what is now a rod assembly 40 to provide adjustable height. Rod assembly 40 here includes a sleeve 32 and a piston rod 40a which are operably held together with a pin or like removable connecting device 35. Height adjustment tube or sleeve 32 is firmly connected to the ball 42 (or other connection device, e.g., pintle) and disposed to reside inside the main body tube or sleeve 30 and move axially therewithin. The sleeve 32 may thus have substantially the same, or often a slightly smaller outside dimension (e.g., diameter) than the inside dimension (e.g., diameter) of the main body tube 30. A removable pin 35 may be used to position the inner sleeve 32 to provide for height adjustment of the inner sleeve 32 to match most trailer/tow vehicle applications. The adjustment of the height of the rod assembly 40 may be such that it is adjustable substantially only at the upper end of the device 10, whereas within the cylinder 50 and the lower part of the external tube 30, the piston rod 40a would/may not actually change heights and thereby not ride at a different height.

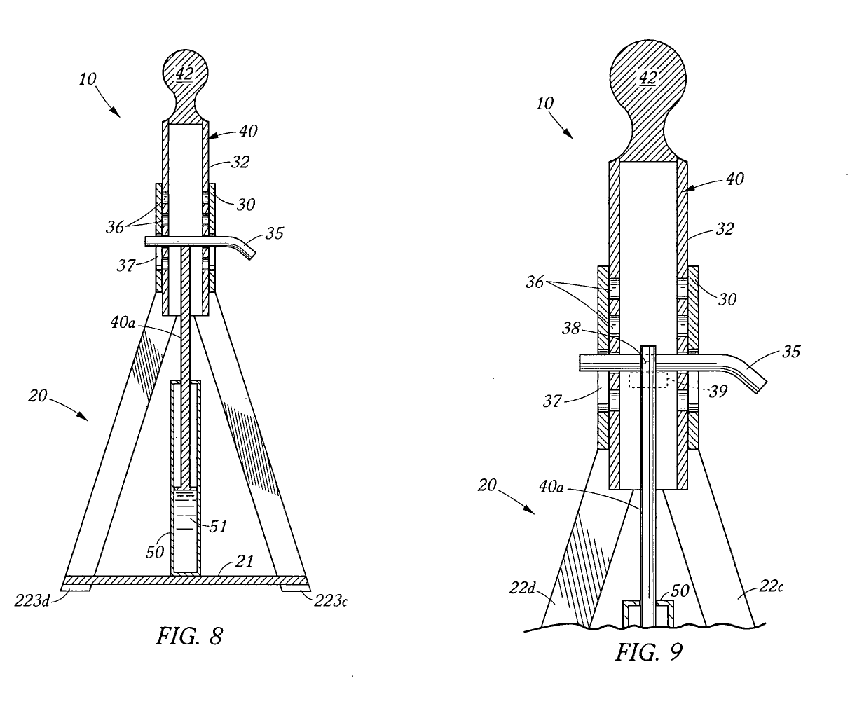

As shown in the embodiment of FIG. 8, the pin 35 interacts with the sleeve 32 of the rod assembly 40, passing through a set of holes 36 therein as well as passing through a pair of slots 37 formed in the external tube 30. Then, the pin 35 can/will contact rod 40a such that the rod assembly 40 via the operative interconnection of sleeve 32 and piston rod 40a may transmit the weight force from the ball 42 to the medium 51 in the cylinder 50. The slots 37 in the outer tube 30 allow vertical movement of the pin 35 as the pin 35 may move with the inner tube 32 within the outer tube 30. Moreover, the pin 35 also interacts with the rod 40a by resting thereon and receives downward force from sleeve 32 and transmits this to the piston rod 40a. However, in the embodiment of FIG. 9, the pin 35 is shown connected to the rod 40a by, for example, having been passed through a hole 38 (indicated by dashed lines) in the top portion of the rod 40a. Or, alternatively, the rod 40a may have an extended seat 39 (shown in phantom, dashed lines) to provide heightened ensurance of interaction of the pin 35 with the rod 40a. Other features could also or alternatively be provided for this purpose as well, as for example a grooved or otherwise shaped portion in the seat 39 to receive and engage the pin 35.

In many embodiments, the tube 30 may have a square cross-section, and the rod 40 (and sleeve 32, if used) would usually be selected to match also with a square cross-section. Circular or elliptical or other polygonal shapes may be used as well. Non-matching shapes may be used, as for example, having a round cylindrical rod 40 in a square cross-sectional tube 30, or vice versa. Note also, though two sizes, i.e., a reduction from wide to thinner, are shown for the rod assembly 40 as it reduces to the piston rod 40a, these may alternatively be a single size, and in some embodiments may not be distinguishable parts, but only a single part extending from the ball 42 or other trailer connection device to the force sensitive device 50.

Also, in many instances (though not limitative), the scale 10 may be between 16 and 19 inches tall with a frame height of 12-13 inches. The main one piece base portion with a four leg frame as shown, may be about 12.5 inches tall, with a base plate of approximately 8 inches by 8 inches and a thickness of ¼ inch. Although in some embodiments sleeve 30 and the struts 22 of the frame 20 are formed from separate pieces which are rigidly joined, it may alternatively be that they could be formed from an integral piece if so desired. Scale 10 may itself weigh only a few pounds, however, the exact weight and dimensions of scale 10 would more likely be determined by its desired weighing capacity and the material used in its construction. Typically the rod 40 may have a 1 and ⅛ inch outer diameter. The inner diameter of guide sleeve 30 may be selected to be at or slightly larger than 1¾ inches. Thus a controlled tolerance fit may be assured between rod 40 (or 32) and the mating sleeve 30 of scale 10. Such tolerances may provide for a desirable effect of having sleeve 30 to thereby also appropriately position the rod 40 as described. Rod 40 may thus ride along and possibly be in contact with the inner surface of the sleeve 30 and the rod 40 and/or a possible pressure plate, e.g., piston 44 attached thereto abuts the force sensitive medium 51 in the cylinder 50. Note, also the alternative strut corners 223a, 223c and 223d shown in FIGS. 6, 7 and 8 which are shown extending below the base plate 21, which may be a small amount, e.g., ¼ inch, or a more significant amount.

Any or all materials may be metals, e.g., steel or aluminum, or hard or otherwise strong plastics or any combination hereof. Further alternative materials may be used. Injection molding may be used for a process of manufacturing a frame hereof in plastic, or machining metals is an alternative as well. Guide sleeve 30 may be formed from a material, such as polyethylene to allow the rod 40 and/or the inner tube 32 to slide easily therein and/or therethrough. Lubrication between the sleeve 30 and rod 40 and/or tube 32 may be used, as for example, graphite or oil, or an oil-based, or oil-like substance. As introduced above, the weight or pressure or force sensitive device 50 may be hydraulic/hydrostatic or pneumatic, in one or more of which cases, a weight or pressure or force sensitive fluid medium 51 may be disposed in the tube 50 and communicate with the force indicative device or gauge 60. Furthermore, the piston rod 40a would have a piston 44 or other seal, e.g., an o-ring or the like, at the lower end thereof adjacent the compression contact of the rod 40a or piston 44 with the fluid. Note, the inner diameter of the tube 50 may be conformant with the external diameter of the rod 40a so that no extra piston may be desired. A dust seal may also be disposed adjacent the top opening of the tube 50 where the rod 40a enters.

During a normal weighing operation scale 10 is positioned on a relatively flat spot beneath the trailer socket 13. The rod 40 extending through the sleeve 30 with the supporting end thereof with ball 42 extending upwardly out and above the sleeve(s) 30, and the lower end engaging and depressing the force sensitive medium 51 within cylinder 50, i.e., imposing or impressing a force thereon or thereinto. Then, a load is applied down onto the scale 10 via the ball 42 and the rod 40 to compress or press upon the medium 51. Any other supports, such as the hitch to a towing vehicle, are or will have been removed so that the trailer tongue 15 is supported by the rod 40 and force sensitive medium 51 in and through the scale 10. The scale would then indicate the tongue weight or other force measurement.

The scales disclosed in the preferred embodiments may have any of a large range of measurement capabilities, and for example, may have a capacity of 0-1500 pounds, or a relatively large capacity of up to 2500 or even up to 3000 or 5000 pounds, the 3000 or 5000 pound maximum limits perhaps being at or near a typical design burst pressure of a unit. Larger units are also possible depending upon material and design choices. One or more of pounds or pounds per square inch (psi) and/or kilograms per square centimeter (kg/cm²) may alternatively be the units of choice to be registered on the gauge 60. The user or operator can then read the gauge indication (weight, force, pressure, etc.) and thereby determine whether the load is either minimally appropriate or rather needs re-distribution. Optimization over minimum appropriateness of the ball and socket connected weight may alternatively or additionally be determined. The trailer tongue weight could be checked after the trailer is loaded, or alternately the scale could be placed in position to indicate tongue weight and as the trailer is loaded the load could be distributed to maintain the desired tongue weight. The scale 10 may thus be formed in some embodiments with the strength and stability necessary to safely support the tongue 15 of the trailer 14 while distributing and/or re-distributing the load for either or both minimum appropriateness or even for optimization. Another way to view the weight is as a direct indication of the ball and socket connected weight being or to be applied to the tow vehicle.

As introduced above, many variations of legs 22 may be used, as for example, three legs (not shown) in some cases in a tripodal, equispaced stance. Other numbers of legs would create a polygonal plan view, the type of polygon depending upon the number of legs. The legs or struts may thus be defined as being angularly disposed so as to define at least one of a plan view polygon, a plan view equilateral polygon or a plan view regular polygon at the extended lower ends thereof. Equispacing of the legs so as to provide an equilateral or regular polygon may provide for a more stable support though non-equispacing of the legs, one from another may alternatively be used. Similarly, five or six or other reasonable numbers more equi- or non-equispaced supporting members or legs may be used. Similarly, less or fewer legs, e.g., two or even one leg may be used; although such arrangements may require substantial material strength and or larger or spread or otherwise uneven sizing in order to provide acceptable stability. For example two legs might be fashioned which may be spread at the base level to cover the distance or a substantial portion of the distance between corners 23a and 23b with the second leg disposed opposite the first leg and covering the distance or substantial portion thereof between corners 23c and 23d. Other polygonal plan views may similarly be inequitably spread as in isosceles or other triangles or trapezoids or other quadrilaterals, and so on.

In another alternative embodiment, the frame 20 may be operable without the base 21. In such a case, the struts 22 would reach to and rest upon the ground (or other unattached support surface) and the cylinder would then either or both rest on the ground or be directly connected to and supported by the frame 20 or the sleeve 30.

In alternative embodiments such as those shown in FIGS. 6-9, the adjustment sleeve 32 may be of the same or similar shape to the outer sleeve 30 and/or may be long enough to provide for a number of adjustments, as for example, between two and four or more, giving multiple height possibilities. As such, the spacings of adjustable heights may be on the order of an inch apart or more or less than an inch, as one example. The slot(s) 37 for the pin 35 may be short or elongated depending upon the expected travel of the pin 35 which in turn depends upon the relative weight capacities of the scale 10 and the compressibility of the medium 51 in the cylinder 50. The pin 35 may also have a cotter pin or key hole in the insertable end of the pin 35 for accepting a cotter pin/key (not shown) to lock the pin 35 in place after insertion of the pin 35 in and through the relative holes 36 of the sleeve 32.

The rod assembly 40, whether including merely a one piece rod 40/40a or also including a sleeve 32 connectible to a piston rod 40a, may further include a top portion or plate for connection to the ball 42 and/or such a top plate may be larger or wider than the main frame sleeve 30 so as to provide a final stop or catch of the inner sleeve 32 or rod 40 on the top of the main frame sleeve 30, thereby stopping the rod/sleeve 40/32 from dropping through the main sleeve 30.

The top of the adjustment sleeve 32 may be flat or have a flat portion with a nut or bolt or a like threaded member disposed or connected there, as for example by welding. A nut or like member would/could receive and/or accept a substantially standard trailer ball with a threaded extension (like a bolt), or may similarly or alternatively accept a bolted pintle hitch adaptor. The pintle hitch (sometimes called a tow ring) adapter may simply be a squared U-shape piece with often approximately a two inch inside dimension and two inch sides and one quarter (¼) inch thick with a bolt hole or pre-fabricated threaded rod to thread into the nut or like member welded below the top plate of the adjustment sleeve 32.

An alternative weighing/pressure/force sensitive device, as an alternative to what may in many embodiments be a hydrostatic or pneumatic cylinder 50 (see above), may include use of an alternative medium, such as a compressible spring disposed between a lower closed end of a cylinder or the like and a pressure plate or like connection from a rod 40. As a load is applied to the ball 42 and rod 40, the spring may then be controllably compressed. And, the spring would then have been selected to provide linear compressibility with respect to the weight applied thereto over the selected range, thereby yielding a corresponding indication of weight relative to the amount of compression thereof.

Another alternative may include the guide sleeve 30 having a slotted opening formed therein and calibrated weight indications may then be provided along the sides of such an elongated slot. An indicator could then be attached to the rod 40 which may be exposed for viewing through the slot. A further alternative could include some other movable indicator moving with or as a result of the movement of the rod 40, such an alternative indicator also being marked to provide the indicator. As the rod 40 may then be moved downward under the weight applied through via the ball 42, the applied weight may thus be indicated.

A further alternative may be the provision of an extra pin or screw hole in the main frame sleeve 30 above the shaft 40a for receiving a set screw or other insertion device for engaging the main rod 40 and/or sleeve 32 to support the weight of a trailer tongue for extended periods. Extended periods of pressure may compromise the rod seal integrity, i.e., cause a leak of fluid or air past the rod seal in a hydraulic or pneumatic device. Such a pin or set screw may also be used as a storage pin to reduce seal compromise even without being loaded/weighted.

The scales 10 hereof may be compact and easy to store. One or more embodiments may be portable so that they can be used with a number of trailers, like trailer 14 or otherwise, or carried with a trailer during transport. Such scales 10 can be used on existing trailers 14 without modification of the trailer tongue 15 or the hitch 18. The simple, rugged, relatively inexpensive, portable construction makes any scale 10 hereof usable with a single trailer 14 or retainable at an area where various trailers traffic to check their weight. That is, this trailer tongue weight scale 10 could easily be maintained at a service station, park station, etc. for checking tongue weight on a loaded trailer 14 as a safety service.

The foregoing description has been presented for purposes of illustration and description. It is not intended to be exhaustive or to limit the invention to the precise forms disclosed. Obvious modifications or variations are possible in light of the above teachings. The embodiment or embodiments discussed, however, were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

Accordingly, what is claimed is:

1. A trailer tongue scale comprising:
a frame including:
at least one angularly disposed strut;
a sleeve connected to and supported by the angularly disposed strut; and
a force sensitive device connected to the frame such that the frame supports the force sensitive device; and
a force indication device disposed in operable relationship with the force sensitive device and operable with the force sensitive device to reflect an amount of a force imposed upon the force sensitive device, the reflected amount being indicative of a force measurement; and
a force transmission rod assembly disposed to move within the sleeve and disposed in operative communication with the force sensitive device and disposed to be operatively connected to a trailer tongue and thereby receive a force therefrom and transmit that force to the force sensitive device which provides for the force indication device to reflect the amount of that force.

2. A trailer tongue scale according to claim 1 wherein the force is at least one of weight, mass or pressure or a combination of two or more thereof.

3. A trailer tongue scale according to claim 1 wherein the frame comprises a plurality of angularly disposed struts, each of which being connected to the sleeve.

4. A trailer tongue scale according to claim 1 wherein the frame comprises a plurality of angularly disposed struts, each of which being connected to the sleeve so as to provide vertical and lateral support thereto.

5. A trailer tongue scale according to claim 1 wherein the frame comprises a plurality of angularly disposed struts, each of which being connected to the sleeve so as to provide vertical and lateral support thereto, the struts being angularly disposed so as to define at least one of a plan view polygon, a plan view equilateral polygon or a plan view regular polygon at the extended lower ends thereof.

6. A trailer tongue scale according to claim 1 wherein the frame comprises a base plate connected to the at least on strut; whereby the force sensitive device is connected to the base plate.

7. A trailer tongue scale according to claim 1 wherein the frame comprises a handle.

8. A trailer tongue scale according to claim 1 wherein the sleeve is a substantially hollow member, vertically disposed above the force sensitive device.

9. A trailer tongue scale according to claim 1 wherein the force sensitive device is a fluid cylinder of one or more of the following types: pneumatic, hydraulic or hydrostatic.

10. A trailer tongue scale according to claim 1 wherein the force sensitive device is at least one or a combination of a spring, a deformation device and a deflection device.

11. A trailer tongue scale according to claim 1 wherein the force indication device is at least one or a combination of a needle and a gauge.

12. A trailer tongue scale according to claim 1 wherein the force transmission rod assembly has a wide lateral support portion and a narrower portion for engaging the force sensitive device.

13. A trailer tongue scale according to claim I wherein the force transmission rod assembly has a trailer tongue connection device connected thereto, and in which the trailer tongue connection device is one of a universal ball or a pintle hitch or a tow ring.

14. A trailer tongue scale according to claim 1 wherein the force transmission rod assembly has a tubular member adapted to be connected to the trailer tongue and adapted to move in the frame sleeve, the tubular member having at least two sets of apertures formed therein, the force transmission rod assembly also having a piston rod adapted to engage the force sensitive device;
whereby force transmission rod assembly also has a pin, the pin being adapted to be inserted in and operably disposed in a at least one of said sets of apertures in the tubular member to provide for adjusting the operable height of the force transmission rod assembly, and,
whereby said pin is adapted to engage said piston rod and thereby transmit force received from the tubular member to the piston rod which is thereby adapted to transmit that force to the force sensitive device.

15. A trailer tongue scale according to claim 1 wherein at least one part of the frame is made from one of metal or plastic; by one of machining, molding or injection molding.

16. A trailer tongue scale comprising:
a frame including:
a sleeve; and
a force sensitive device connected to the frame such that the frame supports the force sensitive device; and
a force indication device in operable relationship with and operable with the deformation device to reflect the amount of the force sensitive device, the amount being indicative of a weight measurement, and
a force transmission rod assembly including a rod and a conventional trailer tongue connection device, the rod assembly being disposed to move within the sleeve and disposed in operative communication with the force sensitive device and disposed to be operatively connected to a trailer tongue and thereby receive a force therefrom and transmit that force to the force sensitive device which provides for the force indication device to reflect the amount of that force.

17. A trailer tongue scale comprising:
a frame;
a force sensitive device connected to the frame such that the frame supports the force sensitive device in operable position;
a force indication device disposed in operable relationship with and operable with the force sensitive device to reflect the amount of force imposed on the force sensitive device, the reflected amount of force being indicative of a force measurement;
a force transmission rod assembly, the rod assembly being disposed to move within the sleeve and disposed in operative communication with the force sensitive device and disposed to be operatively connected to a trailer tongue and thereby receive a force therefrom and transmit that force to the force sensitive device which provides for the force indication device to reflect the amount of that force; and
apparatus providing for altering the operable height of the force transmission rod assembly.

18. A trailer tongue scale according to claim 17 in which the force transmission rod assembly includes a tubular member adapted to he connected to the trailer tongue and adapted to move in the sleeve, the tubular member having at least two sets of apertures formed therein, the force transmission rod assembly also having a piston rod adapted to engage the force sensitive device;
the apparatus providing for altering the operable height of the force transmission rod assembly including a pin, the pin being adapted to be inserted in and operably disposed in a at least one of said sets of apertures in the tubular member, and, said pin being adapted to engage said piston rod and thereby transmit force received from the tubular member to the piston rod which is thereby adapted to transmit that force to the force sensitive device.

19. A trailer tongue scale according to claim 18 wherein the sleeve further includes a pair of slots formed therein and therethrough, the slots being operable with the pin to allow movement of said pin with the tubular member of the force transmission rod assembly.

20. A method for measuring the weight force of a trailer tongue comprising:
providing an adjustable height trailer tongue scale having a frame, a trailer tongue connection, an adjustable height weight force transmission rod assembly, a weight force sensitive device and a weight force indication device;
disposing the scale in operative position adjacent the trailer tongue;
adjusting the trailer tongue scale to the appropriate operable height of the trailer tongue;
connecting the trailer tongue to the trailer tongue connection device; and
reading a weight force from the scale.
